(19) United States
(12) Patent Application Publication
(10) Pub. No.: US 2010/0056103 A1
(43) Pub. Date: Mar. 4, 2010

(54) Method for indicating subscription to a green service in a message

(76) Inventors: David A. Jones, Orland Hills, IL (US); John C. Zglobicki, Plano, IL (US)

Correspondence Address: Lucent Technologies Inc.;Docket Administrator, Room 2F-192, 600-700 Mountain Ave., Murray Hill, NJ, 07974-0636, US

(21) Appl. No.: 12/231,241

(22) Filed: Aug. 29, 2008

(51) Int. Cl. H04M 11/00

(52) U.S. Cl. 455/406; 455/466

(57) ABSTRACT

The present invention provides a method for utilizing a green messaging service. A base station receives a Short Message Service (SMS) message from a messaging unit. A controller determines whether the messaging unit has subscribed to a green service. If the messaging unit has subscribed to the green service, the controller changes the received SMS message to a green SMS message.

### FIELD OF THE INVENTION

The present invention relates generally to communication systems, and more particularly to messaging services.

### BACKGROUND OF THE INVENTION

Many scientists are concerned about the impact of greenhouse gases on the environment. One approach to addressing the possible impact of greenhouse gases on the environment is through the installation and use of alternative energy sources.

One problem with alternative energy sources is cost. If alternative energy sources were cost-effective, they would have wide acceptance and would no longer be considered “alternative”.

In a highly competitive economic environment it is difficult to pass on higher energy costs to customers. Therefore, a need exists for a method of decreasing the use of fuels that generate greenhouse gases that is economically feasible.

### BRIEF SUMMARY OF THE INVENTION

The present invention relates generally to providing a green service in a communication system. A wireless network receives a text message from a messaging unit. The text message is preferably a Short Message Service (SMS) message.

The wireless network determines whether the messaging unit has subscribed to the green service, preferably by having a base station communicate with a processor within the wireless network. The processor determines if the messaging unit has subscribed to the green service. The processor preferably accesses a subscriber database and checks a field in a subscriber record associated with the messaging unit. If the messaging unit has not subscribed to the green service, the wireless network sends the originally received text message.

If the messaging unit has subscribed to the green service, the processor changes the received text message to a green text message. The green text message includes the text of the received text message and an indication that the message is an environmentally-friendly message. For example, the indication can be an image, a change to the formatting of the text, a background change, or any other indication that the message being received is from an environmentally-conscious user.

In one exemplary embodiment, the image is an icon, such as a picture of earth, the recycling symbol, a tree, or any other image that relates to the environment.

In a further exemplary embodiment, the text is changed to indicate the subscription to the green service. For example, the text of the message can be changed to green to indicate to the recipient that the sender subscribes to the green service.

In a further exemplary embodiment, the background of the message is changed to indicate that the sender has subscribed to the green service. For example, the background of the green SMS message can be changes to green, or can have a pattern that reminds the recipient of the environment, such as a waterfall, a forest, tree bark, or any other environmentally-friendly background.

The wireless network preferably charges a green account associated with the messaging unit that sends the green text message. This allows the user of the sending messaging unit to pay a fee for each message sent or paying a monthly service fee, thereby offsetting a portion of his or her energy usage.

In one exemplary embodiment, the wireless network invites the message recipient to join the green service by sending an invitation text message to the receiving messaging unit. The invitation text message is a message that invites the receiving messaging unit to subscribe to the green service. If the receiving messaging unit responds affirmatively, such as by sending a text message back to the wireless network, the wireless service provider enrolls the receiving messaging unit in the green service. The invitation text message can include a link to a website that includes details about the green service.

In accordance with a first exemplary embodiment, the sending messaging unit is charged a fixed amount for each message sent. The sending messaging unit can alternately be charged an amount based upon various factors, such as the length of the message, the estimated amount of energy used to send the message, the number of cell sites involved in sending the message, the time of day, or other factors.

Once the text message has been changed to a green text message, the base station sends the green text message to a receiving messaging unit.

### BRIEF DESCRIPTION OF THE SEVERAL VIEWS OF THE DRAWINGS

FIG. 1 depicts a wireless communication system in accordance with an exemplary embodiment of the present invention.

FIG. 2 depicts a flowchart of a method for utilizing a green messaging service in accordance with an exemplary embodiment of the present invention.

FIG. 3 depicts a flowchart of a method for inviting a message recipient to join the green messaging service in accordance with an exemplary embodiment of the present invention.

### DETAILED DESCRIPTION OF THE INVENTION

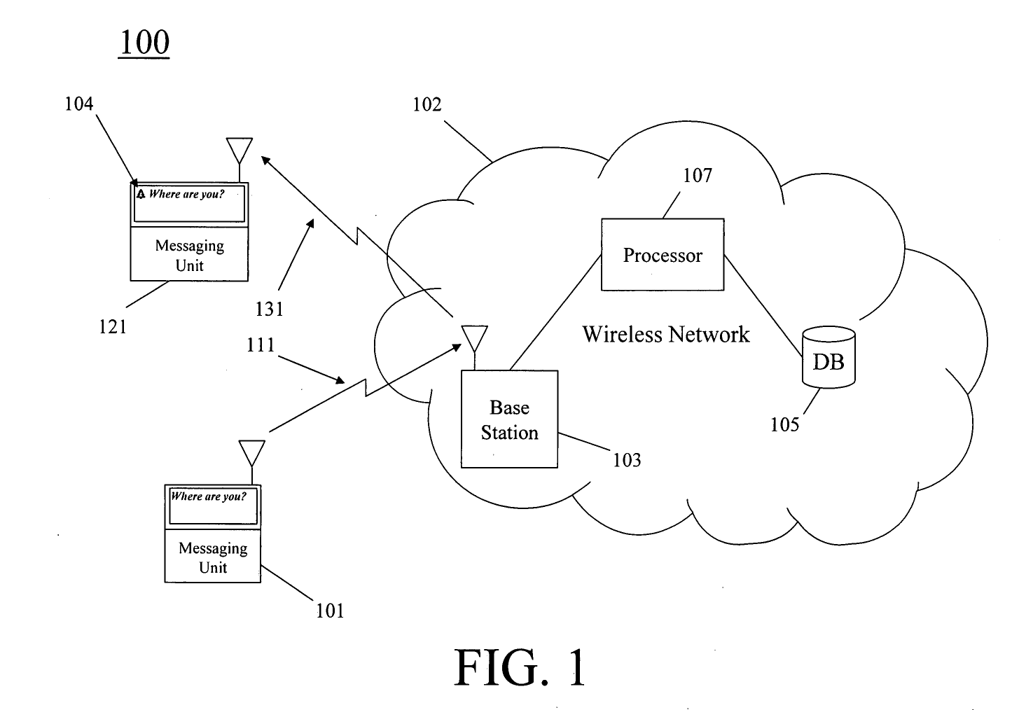

The present invention can be better understood with reference to FIGS. 1-3. FIG. 1 depicts wireless communication system 100 in accordance with an exemplary embodiment of the present invention. Wireless communication system 100 includes messaging unit 101, messaging unit 121, and wireless network 102. Wireless network 102 includes base station 103, database 105, and processor 107.

It should be understood that wireless communication system 100 typically includes a plurality of messaging units and wireless network 102 preferably includes a plurality of base stations and also additional equipment, but only messaging units 101 and 131, base station 103, database 105, and processor 107 are depicted in FIG. 1 for the sake of clarity.

Wireless network 102 is a network that facilitates communication between messaging units and other messaging units or devices connected to networks that are connected to wireless network 102.

Base station 103 is a network element that provides over-the-air communication with messaging units and also communication with core network elements within wireless network 102. Wireless network 102 preferably includes a plurality of base stations.

Database 105 includes information regarding the service provided to subscribing messaging units, such as messaging unit 101. Database 105 includes messaging plan information for messaging unit 101 and other messaging units. In an exemplary embodiment, database 105 includes information about what services subscribers have subscribed to as well as information on the types of indications that are available.

Processor 107 is a processor that receives an SMS message from base station 103 and determines if the sender of the SMS message has subscribed to a green service. This is preferably accomplished by checking a subscriber record associated with messaging unit 101 to determine if messaging unit has subscribed to the green service. In an exemplary embodiment, there is a flag in the subscriber record that indicates whether messaging unit 101 has subscribed to the green service.

Processor 107 also determines how the received SMS message should be changed into a green SMS message. In an exemplary embodiment, processor 107 makes this determination by checking information in the subscriber record associated with message unit 101. Messaging unit 101 can preferably choose how messages sent using the green service appear to the recipient.

In an exemplary embodiment, messaging unit 101 pays a fee for the green service. The revenue generated from these fees is preferably placed into a green funds account or some other fund that is used to promote green energy usage. The green fund account is preferably distinct from an operational account. Money in the green fund account is preferably used to pay for environmentally-friendly goods and services. For example, funds from the green funds account may be used to purchase power from companies that obtain their power from renewable energy sources. Alternately, funds from the green funds account may be used to purchase new equipment that is energy-efficient to replace older less energy-efficient equipment. Further, funds from the green funds account may be invested in research efforts into energy-efficient technology.

Messaging unit 101 is preferably a mobile phone that includes the ability to send text messages. Messaging unit 101 can alternately be a pager or any other unit that is capable of sending text messages. For example, messaging unit 101 can be a cellular phone, a pager, a wireless terminal, a landline phone, a Voice over IP (VOIP) phone, or any other equipment that is capable of sending a message to another user.

Signal 111 is an over the air signal that is transmitted between messaging unit 101 and base station 103. In an exemplary embodiment, signal 111 is an SMS message.

Signal 131 is an over the air signal that is transmitted between base station 103 and messaging unit 101. In an exemplary embodiment, signal 131 is a green SMS message that includes the text from signal 111 but also includes an indication that the sender of the SMS message has subscribed to a green SMS service.

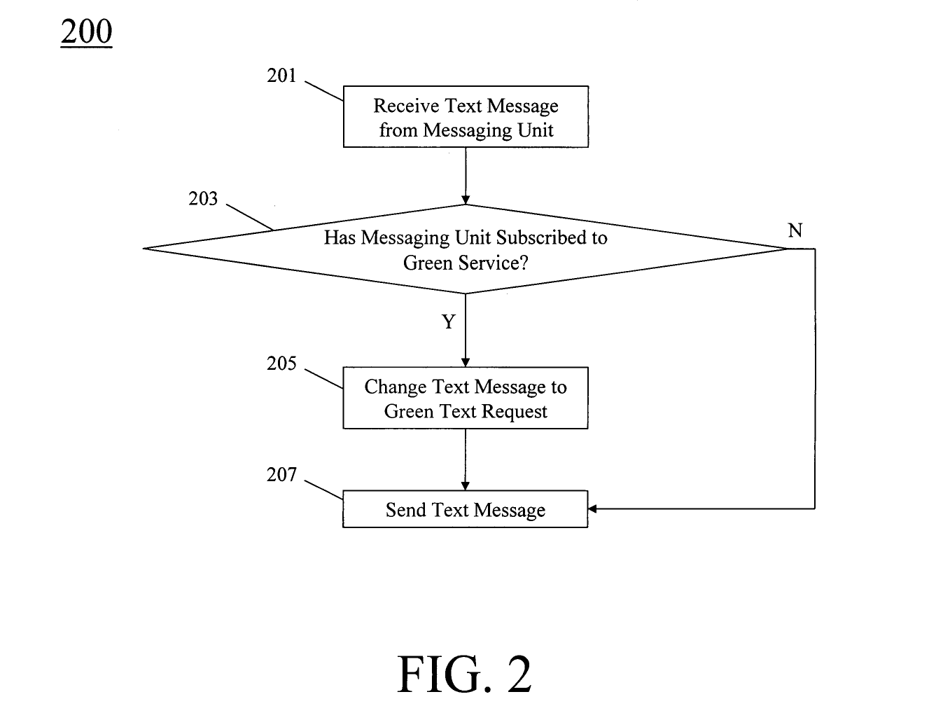

FIG. 2 depicts a flowchart 200 of a method for utilizing a green messaging service in accordance with an exemplary embodiment of the present invention.

Wireless network 102 receives (201) a text message 111 from messaging unit 101. Text message 111 is preferably a Short Message Service (SMS) message.

Wireless network 102 determines (203) whether the messaging unit has subscribed to the green service. In an exemplary embodiment, base station 103 communicates with processor 107 to determine if the messaging unit has subscribed to the green service. Processor 107 preferably accesses database 105 and checks a field in a subscriber record associated with the messaging unit. If the messaging unit has not subscribed to the green service, the process proceeds to step 207 to send the originally received text message.

If messaging unit 101 has subscribed to the green service as determined at step 203, processor 107 changes (205) the received text message to a green text message. In a exemplary embodiment, the green text message includes the text of the received text message and an indication that the message is an environmentally-friendly message. For example, the indication can be an image, a change to the formatting of the text, a background change, or any other indication that the message being received is from an environmentally-conscious user.

In one exemplary embodiment, the image is an icon, such as a picture of earth, the recycling symbol, a tree, or any other image that relates to the environment.

In a further exemplary embodiment, the text is changed to indicate the subscription to the green service. For example, the text of the message can be changed to green to indicate to the recipient that the sender subscribes to the green service.

In a further exemplary embodiment, the background of the message is changed to indicate that the sender has subscribed to the green service. For example, the background of the green SMS message can be changes to green, or can have a pattern that reminds the recipient of the environment, such as a waterfall, a forest, tree bark, or any other environmentally-friendly background.

In accordance with an exemplary embodiment, wireless network 102 charges a green account associated with messaging unit 101. This allows the user of messaging unit 101 to pay a fee for each message sent, thereby offsetting a portion of his or her energy usage.

In accordance with a first exemplary embodiment, messaging unit 101 is charged a fixed amount for each message sent. In accordance with a second exemplary embodiment, messaging unit 101 is charged an amount based upon various factors, such as the length of the message, the estimated amount of energy used to send the message, the number of cell sites involved in sending the message, the time of day, or other factors.

Base station 103 sends (207) green text message 131 to messaging unit 121.

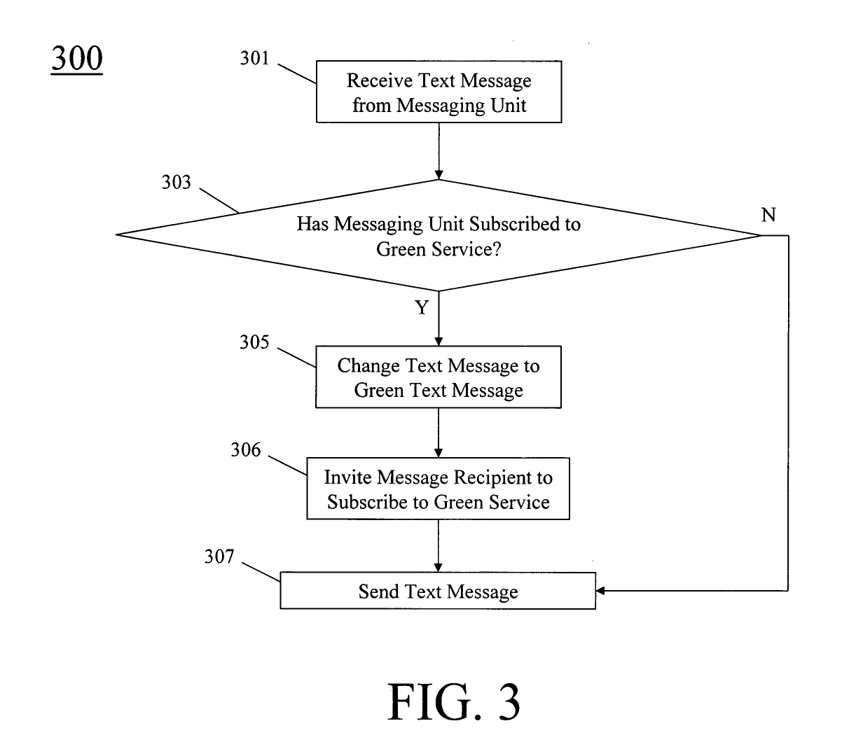

FIG. 3 depicts a flowchart 300 of a method for inviting a message recipient to join the green messaging service in accordance with an exemplary embodiment of the present invention.

Wireless network 102 receives (301) a text message 111 from messaging unit 101. Text message 111 is preferably a Short Message Service (SMS) message.

Wireless network 102 determines (303) whether messaging unit 101 has subscribed to the green service. In an exemplary embodiment, base station 103 communicates with processor 107 to determine if the messaging unit has subscribed to the green service. Processor 107 preferably accesses database 105 and checks a field in a subscriber record associated with the messaging unit. If the messaging unit has not subscribed to the green service, the process proceeds to step 207 to send the originally received text message.

If messaging unit 101 has subscribed to the green service, wireless network 102 performs steps 305 and 307.

Processor 107 changes (305) the received text message into a green text message. In a exemplary embodiment, the green text message includes the text of the received text message and an indication that the message is an environmentally-friendly message. For example, the indication can be an image, a change to the formatting of the text, a background change, or any other indication that the message being received is from an environmentally-conscious user.

In one exemplary embodiment, the image is an icon, such as a picture of earth, the recycling symbol, a tree, or any other image that relates to the environment.

In a further exemplary embodiment, the text is changed to indicate the subscription to the green service. For example, the text of the message can be changed to green to indicate to the recipient that the sender subscribes to the green service.

In a further exemplary embodiment, the background of the message is changed to indicate that the sender has subscribed to the green service. For example, the background of the green SMS message can be changes to green, or can have a pattern that reminds the recipient of the environment, such as a waterfall, a forest, tree bark, or any other environmentally-friendly background.

In the exemplary embodiment depicted in FIG. 3, wireless network 102 invites (306) the message recipient, messaging unit 121, to join the green service. In an exemplary embodiment, the wireless network sends an invitation text message to messaging unit 121. The invitation text message is a message that invites messaging unit 121 to subscribe to the green service. If messaging unit 121 responds affirmatively, such as by sending a text message back to the wireless network, the wireless service provider enrolls messaging unit 121 in the green service. In an exemplary embodiment, the invitation text message can include a link to a website that includes details about the green service. In order to avoid network congestion and annoying the message recipient, wireless network 102 only sends the invitation to each individual message recipient a predetermined number of times.

Base station 103 sends (307) green SMS message 131 to messaging unit 121.

While this invention has been described in terms of certain examples thereof, it is not intended that it be limited to the above description, but rather only to the extent set forth in the claims that follow.

We claim:

1. A method comprising:
receiving a text message from a first messaging unit;
determining if the first messaging unit has subscribed to a service; and
if the communication unit has subscribed to the service, changing the text message to include an indication that the first messaging unit has subscribed to the service.

2. A method in accordance with claim 1, the method further comprising the step of inviting a recipient of the text message to join the service.

3. A method in accordance with claim 1, the method further comprising the step of charging an account of the first messaging unit for the service by charging the account each time the first messaging unit sends a text message.

4. A method in accordance with claim 3, wherein the step of charging the account each time the first messaging unit sends a text message comprises charging the account a fixed amount each time the first messaging unit sends a text message.

5. A method in accordance with claim 3, wherein the step of charging the account each time the first messaging unit sends a text message comprises charging the account a variable amount each time the first messaging unit sends a text message.

6. A method in accordance with claim 5, wherein the step of charging the account a variable amount each time the first messaging unit sends a text message comprises charging the account an amount that is based upon the length of the text message.

7. A method in accordance with claim 5, wherein the step of charging the account a variable amount each time the first messaging unit sends a text message comprises charging the account an amount that is based on the estimated amount of energy used to send the text message.

8. A method in accordance with claim 5, wherein the step of charging the account a variable amount each time the first messaging unit sends a text message comprises charging the account an amount that is based on the time of day.

9. A method for utilizing a green messaging service comprising:
receiving a Short Message Service (SMS) message from a messaging unit;
determining whether the messaging unit has subscribed to a green service; and
if the messaging unit has subscribed to the green service, changing the received SMS message to a green SMS message.

10. A method for utilizing a green messaging service in accordance with claim 9, wherein the step of changing the received SMS message to a green SMS message comprises adding an indication to the SMS message, wherein the indication relates to the green service

11. A method for utilizing a green messaging service in accordance with claim 10, wherein the indication comprises an image.

12. A method for utilizing a green messaging service in accordance with claim 11, wherein the image comprises an icon.

13. A method for utilizing a green messaging service in accordance with claim 11, wherein the image comprises a picture of earth.

14. A method for utilizing a green messaging service in accordance with claim 11, wherein the image comprises a recycling symbol.

15. A method for utilizing a green messaging service in accordance with claim 10, wherein the indication comprises a change to the formatting of the text of the SMS message.

16. A method for utilizing a green messaging service in accordance with claim 15, wherein the change to the formatting of the text comprises changing the color of the text.

17. A method for utilizing a green messaging service in accordance with claim 10, wherein the indication comprises a background change of the SMS message.

18. A method for utilizing a green messaging service in accordance with claim 17, wherein the background change comprises changing the background to green.

19. A method for utilizing a green messaging service in accordance with claim 17, wherein the background change comprises changing the background to a predetermined pattern.

20. A method for utilizing a green messaging service in accordance with claim 19, wherein the predetermined pattern comprises a nature scene.
